(19) United States
(12) Patent Application Publication
(10) Pub. No.: US 2024/0247966 A1
(43) Pub. Date: Jul. 25, 2024

(54) GRID SENSOR, GRID SENSOR SYSTEM, EVALUATION DEVICE AND COMPUTER PROGRAM PRODUCT FOR CORRECTING AN INTERFERING INFLUENCE OF ONE OR MORE FLUIDS

(71) Applicant: Helmholtz-Zentrum Dresden - Rossendorf e.V., Dresden (DE)

(72) Inventors: Eckhard SCHLEICHER, Dresden (DE); Felipe DE ASSIS DIAS, Dresden (DE); Martin LÖSCHAU, Radeberg / OT Rossendorf (DE); Marco Jose DA SILVA, Linz (AT)

(21) Appl. No.: 18/573,442

(22) PCT Filed: Jun. 21, 2022
(86) PCT No.: PCT/EP2022/066803

§ 371 Date: Dec. 22, 2023

(30) Foreign Application Priority Data
Jun. 25, 2021 (DE) 10 2021 116 540.7

(51) Int. Cl. G01F 25/00; G01D 21/00

(52) U.S. Cl. CPC G01F 25/00; G01D 21/00

(57) ABSTRACT

Disclosed herein is a grid sensor, a grid sensor system, a measuring device, and a computer program for correcting an interference caused by one or more fluids. The grid sensor includes a fluid guide region, an electrode, a reference element, and a plurality of grid sensor units, each of which include a group of sensor elements configured to generate measurement signals representing one or more properties of a fluid guided in the fluid guide region. The sensor elements are connected to the electrode for operating the sensor elements. The reference element is associated with the electrode, connected to the electrode, and configured to provide a reference signal representing an interference from the fluid guided in the fluid guide region on an electrical characteristic of the electrode.

### CROSS REFERENCE TO RELATED APPLICATION(S)

This application is a national phase of PCT/EP2022/066803 filed on Jun. 21, 2022, which claims priority to German Patent Application No DE 10 2021 116 540.7 filed on Jun. 25, 2021, the contents of both of which are fully incorporated herein by reference.

### TECHNICAL FIELD

Various embodiments relate to a grid sensor, a grid sensor system, an evaluation device and a computer program product, each of which is suitable for correcting an interference from one or more fluids on the grid sensor, the grid sensor system, measurement data of an evaluation device and measurement data of the computer program product.

### BACKGROUND

In general, grid sensors may be used to examine multiple components (e.g., phase components and/or fluid components) in a fluid stream, wherein the multiple components of the fluid stream differ in at least one electrical property.

For example, a capacitive grid sensor may be used to investigate the fluid flow. The capacitive grid sensor may be used for small sensor areas (e.g. less than 10 cm²) and for a fluid flow comprising only components with low conductivities (e.g. in deionized water).

For example, capacitive displacement currents may be measured using the transmitting wires and receiving wires of a grid sensor. An additional electrically non-insulated wire level may be used to connect all parts of the conductive fluid to a ground potential, whereby these parts may be set to the ground potential (e.g. 0 V) on the signal side.

Conventional grid sensors may already be unsuitable for fluids comprising at least one conductive component (e.g. a conductive phase component and/or a conductive liquid component) with a higher conductivity than that of a deionized water (e.g. tap water). For example, non-linearities may occur due to the conductive components, which may result in signal loss along the receiver wires, e.g. due to energy dissipation. The signal losses may increase proportionally with the composition of the fluid flow (e.g. the conductivity of the conductive portion of the fluid flow, and/or the total conductivity of the fluid flow) and/or with a nature of the transmitting wires and receiving wires (e.g. with a length of the wires, a number of the wires, a wire density, and/or a number of crossing points of the wires). The losses may depend on the respective wetting of crossing points of the transmitting wires and receiving wires with the conductive portion of the fluid flow. Since the wetting of the crossing points may change constantly, the losses may also change constantly. In general, the losses may lead to non-linearities and an underestimation of the measured values on all receiving wires that are in contact with the conductive fluid.

Even with a higher number of transmitting wires and/or receiving wires (e.g. more than 10 each) and/or larger geometries (e.g. a sensor area of more than 20 cm²), conventional grid sensors may only quantify the phase components or the liquid components inaccurately or not at all. For example, an exact calibration of all sensor elements may only be realized with great difficulty, especially with the higher number of transmitting wires and/or receiving wires. Conventional grid sensors may be unsuitable for quantifying phase fractions or liquid fractions as long as the conductive phase is the continuous phase.

### BRIEF DESCRIPTION OF THE DRAWINGS

In the following description, various exemplary aspects of the disclosure are described with reference to the following drawings, in which:

FIGS. 1A to 1C each show a schematic representation of one or more groups of sensor elements of a grid sensor according to various aspects;

FIGS. 2 to 3B show schematic representations of various grid sensors according to different aspects;

FIGS. 4 to 6 each show each case a method for correcting one or more measured values of a grid sensor according to various aspects;

FIG. 7 shows schematic representation of different electrode segments of a grid sensor according to different aspects; and

FIGS. 8 and 9 show schematic representations of various grid sensors according to different aspects.

### DESCRIPTION

In the following detailed description, reference is made to the accompanying drawings, which form part thereof and in which specific embodiments in which the invention may be practiced are shown for illustrative purposes.

According to various aspects, there is provided a device and a method enabling measurement of a fluid flow comprising a plurality of phase portions and/or a plurality of fluid portions. At least a phase portion of the plurality of phase portions and/or a fluid portion of the plurality of fluid portions may be (highly) conductive.

According to various aspects, there is provided a device and a method capable of compensating for losses and non-linearities at transmitting electrodes and/or receiving electrodes due to wetting with a conductive portion of the fluid flow.

According to various aspects, a method is provided that may inherently quantify the losses and non-linearities.

According to various aspects, a method is provided which determines one or more corrected or loss-free measured values from one or more measured (e.g. lossy) values of the individual crossing points of the transmitting electrodes and the receiving electrodes in the fluid flow and one or more reference values. The one or more corrected or loss-free measured values may correspond to the real measured values at the crossing points.

According to various aspects, a device and a method are provided with which it is also possible to use a capacitive grid sensor for a fluid flow comprising at least one highly conductive phase component or fluid component.

According to various aspects, a device is provided that may be used to correct the energy losses in receiving wires of a grid sensor. For example, this may enable measurement of conductive and/or highly conductive liquids.

According to various aspects, a device is provided which may be used for measuring multiphase mixtures in which at least one of the phases is conductive and/or highly conductive.

According to various aspects, a method is provided that enables estimation and compensation of energy losses in grid sensors when the grid sensor is used to measure conductive and/or highly conductive fluids (e.g. gases and/or liquids).

According to various aspects, a method is provided that enables the correction of non-linearities in measurements. Thus, for example, the accuracy of a grid sensor may be increased when determining flow-dependent parameters, e.g. when determining a fractional share (e.g. a percentage share of a phase and/or a liquid in the total fluid flow) and/or a respective flow velocity of one or more phases of the fluid flow, and/or a phase velocity and/or one or more concentration ratios (e.g. of different proportions within the fluid, e.g. in the context of a so-called tracer measurement).

According to various aspects, a grid sensor may be provided comprising: a fluid guide region; a plurality of grid sensor units, each of the plurality of grid sensor units comprising a group of sensor elements configured to generate measurement signals representing one or more properties of a fluid carried in the fluid guide region; an electrode, wherein the sensor elements of the group of sensor elements are connected to the electrode for operating the sensor elements of the group of sensor elements; a reference element associated with the electrode, connected to the electrode, and configured to provide a reference signal representing an interference from the fluid carried in the fluid guide region with an electrical characteristic of the electrode.

Thus, illustratively, in various aspects, a device that may inherently quantify losses and non-linearities is provided. The reference element, which is not influenced by the fluid flow, may provide a reference value that may represent a signal from an electrode. Since both a geometry and the materials are not changed, measurable changes in the reference value that occur may be attributed to a change in the signal (e.g. a signal loss or a signal gain) along a respective electrode (e.g. transmitting electrode and/or receiving electrode).

According to various aspects, the reference electrode may be arranged in a base plate of the grid sensor. For example, the reference electrode may determine (e.g. measure) a reference value (e.g. a capacitance, a temperature, an inductance) by means of a carrier material (e.g. a printed circuit board).

According to various aspects, a grid sensor system may be provided comprising: a grid sensor, a determination device configured to determine the reference signal and to determine the measurement signals, and wherein a measurement signal of each of the measurement signals is associated with a sensor element of the group of sensor elements.

According to various aspects, a grid sensor system may comprise: a fluid guide region for guiding a fluid; an electrode disposed in the fluid guide region; a reference signal source (e.g., the reference transmitting electrode excited by a voltage source providing a reference excitation voltage) for generating a reference signal (e.g., a reference current or a reference voltage) in the electrode; a reference signal receiver for receiving the reference signal (e.g., as a current or voltage); and a signal evaluation unit for evaluating the received reference signal, wherein the received reference signal represents an interference from the fluid flowing in the fluid guide region on an electrical characteristic of the electrode. It is understood that a reference signal in the form of a voltage may be assigned to a current and vice versa, for example by means of a resistor.

According to various aspects, an evaluation device (e.g. measuring device) comprising an input interface configured to receive measurement data and reference data from a grid sensor, wherein the grid sensor may be at least partially flowed around by one or more fluids, wherein the measurement data represents at least one property of the one or more fluids and comprises an interference from the one or more fluids on the grid sensor, and wherein the reference data represents the interference from the one or more fluids on the grid sensor; one or more processors configured to perform a measurement correction for creating corrected measurement data based on the measurement data and the reference data, wherein the measurement correction corrects the interference from the one or more fluids on the grid sensor; and an output interface for outputting the corrected measurement data representing at least one property of the one or more fluids and being independent of the interference from the one or more fluids on the grid sensor.

According to various aspects, a computer program product may comprise instructions for causing one or more processors to perform the following: loading a data set comprising a calibration value, a first group of measurement values, and a first reference value, wherein the calibration value represents a calibration interference from exactly one fluid of one or more fluids on a group of sensors, wherein the first reference value represents a first interference on the group of sensors by the one or more fluids, wherein each measured value of the first group of measured values represents a property of the one or more fluids and the first interference on the group of sensors, and wherein each measured value of the first group of measured values is associated with one sensor of a group of sensors; determining a correction value from the calibration value and the first reference value; and correcting each reading of the first group of readings using the correction value. For example, an influence of only air on the electrode may be understood to be free of interference, as this does not cause a substantial current leakage from the electrode (e.g. less than 0.1% of the total leakage). For example, under this consideration, the calibration value may be measured without interference if the electrode is only exposed to air. Depending on the measurement setup, other conditions may also define a corresponding calibration value as interference-free, e.g. in each case one of several fluids to be measured, which has the lower interference.

According to various aspects, fluids, portions of a fluid (e.g. phase portions and/or fluid portions) and/or components may be described as electrically conductive (or conductive for short). Media comprising a conductivity of more than 0.1 μS/cm (e.g. more than 1 μS/cm, 100 μS/cm, 400 μS/cm) are referred to as conductive. Electrically highly conductive (or highly conductive for short) may be defined as electrically conductive media that have an (electrical) conductivity of more than 500 μS/cm (e.g. more than 1000 μS/cm, 10000 US/cm, 50000 μS/cm).

According to various aspects, one or more fluids may flow through one or more components, or along or past one or more components. Each of the one or more fluids may have a flow velocity and may be referred to as a fluid stream or flowing fluid. It should be noted that each fluid may also mean a fluid flow. It should also be noted that in the following, “a fluid” may also mean “one or more fluids” (e.g. a mixture of one or more fluids), unless explicitly stated otherwise or apparent from the context. According to various aspects, each fluid of one or more fluids may comprise one or more portions (e.g., one or more components, and/or multiple portions that differ from each other in at least one property (e.g., a temperature, a density)). A portion may also be referred to as a phase. A portion of a fluid may, for example, be an aggregate state of a portion of the fluid (e.g. solid, liquid and/or gaseous). A fluid may be a liquid, and/or a gas, and/or a fluidized solid. For example, one or more fluids may comprise one or more liquids. For example, one or more fluids may comprise one or more gases. For example, one or more fluids may comprise one or more gases and one or more liquids. For example, one or more fluids different from one another may have at least one property different from one another. Each of the one or more fluids may have one or more of the following properties: a temperature, a pressure, a viscosity, an electrical property (e.g., an electrical conductivity, an impedance, a relative permeability, an electrical charge), a magnetic property, a physical state, a nuclear charge number, a chemical composition, and/or a velocity (e.g., a flow rate). For example, the fluid may also comprise one or more solids, e.g. in the form of solid particles (e.g. with a diameter smaller than 0.5 cm, 0.1 cm or smaller than 0.01 cm), provided that the overall properties of such substances or mixtures of substances (e.g. emulsions, e.g. sand, or the like) have a fluid character.

For example, a percentage of a fluid or a fluid flow may be a mass (or a volume) of a proportion in relation to the total mass (or the total volume) of the fluid. For example, all percentages may add up to 100%.

Signals are processed according to various aspects, e.g. transmitted, received, processed, modified, etc. A signal that is transmitted by means of an electrode (e.g. a transmitting electrode) may be referred to as a transmit signal or transmitted signal. A signal that is received by means of an electrode (e.g. a receiving electrode) may be referred to as a receive signal, received signal or measurement signal. Between the transmission of the signal from a signal origin via the transmitting electrode and the reception of the signal at a signal destination, the signal may be changed by one or more interactions, e.g. with the one or more fluids and/or with components of the grid sensor, before it may be received. Without an interaction, the received signal may be the same as the transmitted signal (i.e. no difference occurs). For example, the electrode may be wire-shaped (e.g. a wire). For example, the electrode may be sword-shaped. For example, the electrode may be plate-shaped. For example, the electrode may be a conductor track on a printed circuit board. For example, an electrode may be held in half sections (e.g. on a substrate (e.g. a printed circuit board). For example, the electrode may be exposed between two (e.g. adjacent) holding sections. For example, between two (e.g. adjacent) holding sections, the electrode may have no contact with solid material (e.g. the substrate, e.g. the printed circuit board). This allows a fluid-to-be-measured to enter a region of the electrode.

The interactions may generate at least one difference between the transmitted and the received signal. The difference may, for example, represent at least one property of the one or more fluids and/or of at least one of the components of the grid sensor. The difference may, for example, additionally (or entirely) represent one or more interferences. Each of the interferences may, for example, increase or decrease the difference. For example, different interferences of the one or more interferences may compensate each other. Interference may be unintentional and may render the measurement results of a sensor unusable.

According to various aspects, reference elements may be used to determine interference. For example, a reference element may be a component that outputs a constant and/or predetermined or predefined output signal as a function of an input signal (a so-called excitation signal). For example, the reference element may generate the output signal. For example, the reference element may be a passive component comprising a known transfer function between a first and a second electrode. Illustratively, the reference element may output the input signal, which may be provided by a first electrode on the reference element, with a known transfer function (which may result in a known change, for example) as the output signal of the reference element from the reference element, for example to a second electrode. It is understood that the reference element may be configured such that the output signal is equal to the input signal. For example, the input signal may be changed within the reference element in a predetermined manner and output as an output signal with the predetermined change. Due to interference, the output signal of the reference element may be changed and received as a reference signal. For example, the output signal may comprise one or more predetermined or predefined of the following characteristics: a current, a voltage, a resistor, a frequency, a wavelength, an intensity, a duration, a temperature, etc. The signal output by the reference element may be received as a reference signal. The reference signal may, for example, be changed compared to the output signal as a result of the interactions described above. Illustratively, the reference signal may be understood as the output signal under the influence of the interference. For example, one or more interferences may be estimated by comparing the output signal and the reference signal. For example, several reference elements (e.g. different from each other) may be used to determine different interferences. For example, a reference signal that is determined under a predetermined state (e.g. a fulfilled state) may be referred to as a calibration signal. For example, one or more reference values may be derived from a reference signal. For example, one or more calibration values may be derived from a calibration signal.

According to various aspects, a grid sensor may comprise one or more sensor elements. For example, a sensor element may be coupled to a first electrode and a second electrode. For example, a transmission signal may be transmitted from the first electrode within the sensor element to the second electrode. For example, a sensor element may provide a capacitive coupling, and/or a resistive coupling between the first electrode and the second electrode. For example, the sensor element may comprise or consist of one or more of the following: a resistor, a capacitor, a coil, a temperature sensor, a light source, a photodetector, and/or a pressure sensor, or a combination thereof. The reference element may comprise or be one or more sensor elements.

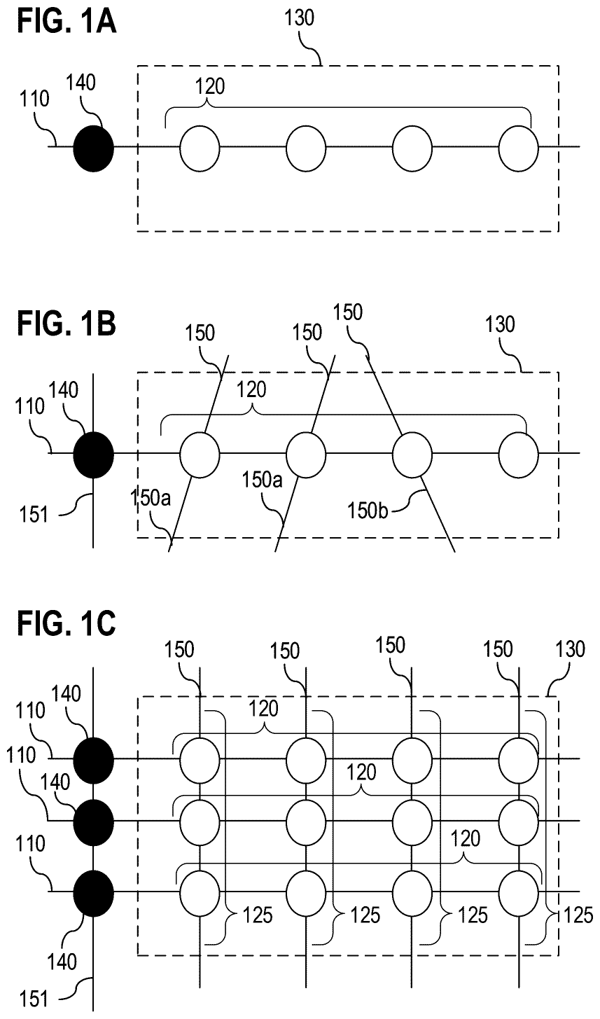

FIG. 1A is a schematic representation of a grid sensor unit of a grid sensor. The grid sensor may comprise: a fluid guide region 130, a group of sensor elements 120, an electrode 110 and a reference element 140. The fluid guide region 130 may be suitable for guiding a fluid or a fluid flow. For example, the group of sensor elements 120 may be suitable for determining one or more properties of the fluid (or fluid flow) as the fluid is guided or flows through the fluid guide region 130. The sensor elements of the group of sensor elements 120 may be connected to the electrode 110 for operating the sensor elements of the group of sensor elements 120. Operating may be understood as reading out, supplying (e.g. with energy), and/or performing a measurement by means of the respective sensor element. The reference element 140 may be associated with the electrode 110. For example, the reference element 140 may be configured to provide a reference signal for determining correction data, which may represent an interference from the fluid on an electrical characteristic (e.g., a resistor, an impedance, a capacitance, and/or an inductance) of the electrode 110 when the fluid is guided in the fluid guide region 130. For example, the reference element 140 may be disposed outside of the fluid flow region 130. For example, the reference element 140 may be configured such that a predefined (or predetermined and/or known) output signal that is output (e.g., transmitted) and/or generated by the reference element 140 is not influenced within the reference element 140 by a fluid flowing in the flow region. Illustratively, this means that the predefined output signal output by the reference element is independent of the fluid guided in the fluid guide region. For example, the reference element 140 may be at least partially encased in a protective layer. For example, the protective layer may shield the reference element from one or more influences of the fluid flowing in the fluid flow region. After the predefined output signal is output from the reference element 140, the predefined output signal may be modified by the influences of the fluid flowing in the flow region. The modified output signal may be received as the reference signal.

FIG. 1B is a schematic representation of a grid sensor unit of a grid sensor. Compared to the grid sensor according to FIG. 1A, the grid sensor according to FIG. 1B comprises several further electrodes 150 and a reference electrode 151. The plurality of further electrodes 150 may lie in a different plane compared to the electrode 110. For example, the electrode and the plurality of further electrodes may be electrically insulated from each other.

In a projection view of the grid sensor, the electrode 110 and the several other electrodes 150 may intersect at at least one point. For example, a sensor element may be arranged at the point of intersection. For example, the sensor element may also be formed by the intersection point. The angle of intersection may be selected anywhere between 0° and 180°. In the following, projections with intersection angles of 90° are frequently shown. The plurality of further electrodes 150 may comprise a plurality of first further electrodes 150a, which may, for example, be arranged parallel to one another. The plurality of further electrodes 150 may comprise, for example, at least one second further electrode 150b. The second further electrode 150b may, for example, not be arranged parallel to the electrodes of the first type 150b. It will be understood that the further electrodes 150 may be arranged generally arbitrarily with respect to each other and with respect to the electrode 110. However, in order to enable optimum functioning of the grid sensor, electrodes that are not to influence each other should be electrically shielded from each other, for example by means of a suitable arrangement of the electrodes and/or by insulating materials. It is understood that the electrodes may be electrically connected to each other via the fluid guided in the flow area.

The reference element 140 may be connected to the electrode 110. The reference element 140 may be connected to a reference electrode 151. The reference electrode 151 may, for example, be arranged such that it is not influenced by a fluid in the fluid guide region. For example, the reference electrode 151 may be arranged outside the fluid guide region 130. For example, the reference electrode 151 may be (at least partially) encased such that it is not influenced by the fluid. Illustratively, the electrode 110, the reference element 140 and the reference electrode 151 may be configured such that a reference signal may only be changed by an influence of the fluid on the electrode 110. For example, the reference electrode 151 may be one of the plurality of further electrodes 150. For example, the reference electrode 151 may be arranged within the fluid guide region 130.

Each sensor element of the group of sensor elements 120 may be connected to both the electrode 110 and to one of the plurality of further electrodes 150. Illustratively, each sensor element may comprise a connection to the electrode and to a respective one of the plurality of further electrodes 150.

For example, the electrode 110 may be configured to transmit a signal (i.e. be configured as a transmitting electrode). For example, the reference electrode 151 and/or the plurality of further electrodes 150 may each be configured to receive a signal (i.e. as receiving electrodes).

To determine a corrected measurement signal, the grid sensor may, for example, be configured to transmit a predetermined transmission signal to the reference element 140 by means of the electrode 110. By means of the reference element 140, the predetermined signal may be transmitted (illustratively forwarded essentially unchanged) to the reference electrode 151 as the reference signal. For example, the reference element 140 may transmit an output signal of the reference element 140 to the reference electrode 151 through the predetermined signal. The output signal may be altered (e.g., amplified or attenuated) by the influence of a fluid carried in the fluid region. The signal received by the reference electrode 151 may be the output signal altered by the influence of the fluid carried in the fluid region 130.

For example, the electrode 110 may be configured to transmit a signal (i.e., a transmit signal). The plurality of further electrodes 150 may be configured such that only one of the plurality of further electrodes 150 may receive the transmit signal via the respective sensor element at any one time. The plurality of further electrodes 150 may be configured such that all of the one of the plurality of further electrodes 150 may receive the transmit signal via the respective sensor element, for example at the same time or within 1 s after a first of the plurality of further electrodes 150 has received the transmit signal. For example, the plurality of further electrodes may be configured such that, after a first electrode has received a first measurement signal, a second electrode may receive a second measurement signal. For example, such a change of the respective receiving electrodes may be carried out until a predetermined number or a predetermined amount of electrodes have each received a measurement signal.

For example, the electrode 110 may be configured to receive a signal (i.e. be configured as a receiving electrode). For example, the reference electrode 151 and the plurality of other electrodes 150 may each be configured to transmit a signal (i.e., as transmitting electrodes).

To determine a corrected measurement signal, the grid sensor may, for example, be configured to transmit a reference transmission signal to the reference element by means of the reference electrode 151. Within the reference element 140, the signal may be transmitted to the electrode 110 as the reference signal. For example, the first further electrodes 150a may be configured to transmit a first transmit signal of the one or more transmit signals. For example, the second electrode may be configured to transmit a second transmit signal. For example, the first and second transmit signals may be identical in all signal characteristics. For example, the first and second transmit signals may differ in at least one signal characteristic. A signal property may be, for example, a duration, an intensity, a wavelength, a frequency, an on-time, and/or an intensity curve.

For example, one of the first further electrodes 150a may transmit the first transmission signal. After a predetermined first time interval, a second of the first further electrodes 150a may transmit the first transmission signal. After a predetermined second time interval, the second further electrode 150b may transmit the second transmission signal. Illustratively, the first and second time intervals may be referred to as first and second pauses, respectively. For example, the first and second time intervals may be of equal or different lengths from each other. For example, a sequence of a plurality of signals and/or a plurality of pauses may be referred to as a signal sequence. For example, a number of signal sequences per second may be referred to as a signal sequence frequency. The electrode 110 may be configured to receive a respective transmitted signal as a measurement signal via a respective sensor element. Such a procedure may be continued in an analog manner until a predetermined number of the plurality of further electrodes 150 have transmitted a signal.

Both when the electrode is configured as a receiving electrode and as a transmitting electrode, the respective determined measured values may be corrected by means of the reference signal. It is understood that the determination of a measurement signal may also take place alternately with the determination of the reference value. Of course, it is also possible to determine several or all measured values and to determine the reference value before or after this.

As is clear from the previous embodiment examples, the reference element may be used on both transmitting electrodes and receiving electrodes. It is also possible to couple several electrodes to each other via different sensor elements. The sensor elements are preferably arranged in a matrix arrangement, i.e. evenly spaced apart. However, it is also possible to arrange the sensor elements in any order. Since a matrix arrangement appears to be more suitable for systematic evaluation, a specific embodiment is shown below:

FIG. 1C is a schematic representation of a plurality of grid sensor units of a grid sensor according to various aspects, wherein each grid sensor unit may be associated with an electrode 110. Each grid sensor unit may comprise at least one reference element 140. The reference element 140 of the respective grid sensor unit may be associated with the respective electrode 110 of the grid sensor unit. The reference elements 140 of the plurality of grid sensor units may be/are connected to a reference electrode 151. It will be understood that each reference element 140 may be connected to a reference electrode 151 comprising no connection to the reference elements 140 of the other grid sensor units. Each grid sensor unit of the grid sensor may comprise a group of sensor elements 120. Each group of sensor elements 120 may be associated with a respective electrode 110 of the grid sensor. The grid sensor may comprise a plurality of further electrodes 150. The plurality of further electrodes 150 may each connect a sensor element of a plurality of grid sensor elements. Each of the plurality of further electrodes 150 may thus form a respective further group of sensor elements 125. Illustratively, each sensor element 120 of the grid sensor may be associated with a group of sensor elements 120 and a further group of sensor elements 125. For example, a sensor element may thus be assigned exactly one transmitting electrode and one receiving electrode. The assignment to the group of sensor elements 120 via the (e.g. common) electrode 110 may also be understood as an assignment to a grid sensor unit.

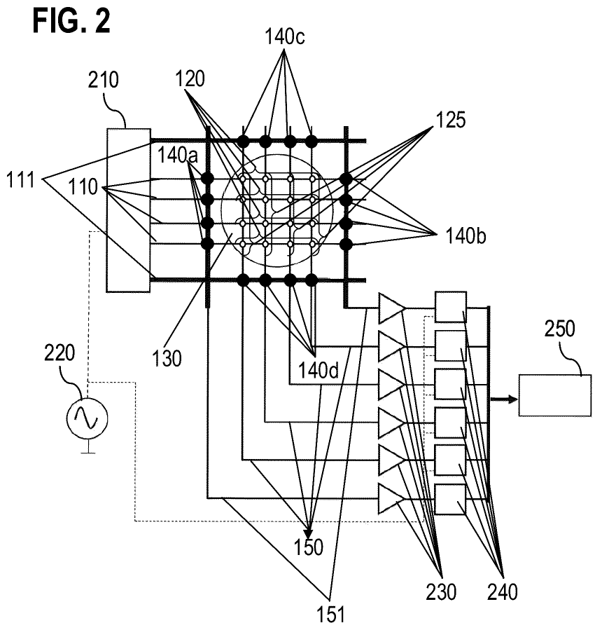

FIG. 2 is an extended schematic representation of the grid sensor according to FIG. 1C. The grid sensor may comprise a plurality of grid sensor units. Each grid sensor unit may comprise an electrode 110, a group of sensor elements 120, one or more reference electrodes and one or more reference elements 140. Further, the grid sensor may comprise a plurality of further electrodes 150, wherein each of the plurality of further electrodes 150 may interconnect a sensor element of mutually different grid sensor units of the plurality of grid sensor units. Sensor units that are connected to each other by means of one of the further electrodes 150 may be assigned to a group of further sensor units 125. Thus, due to the plurality of further electrodes 150, a plurality of groups of further sensor units 125 may be formed. For example, each of the four exemplary electrodes 110 may each be connected to a first reference element 140a and a second reference element 140b. The respective first and second reference elements 140a, 140b may be coupled to respective independent reference receiving electrodes 151 of a plurality of reference receiving electrodes 151. For example, each of the four exemplary further electrodes 150 of the plurality of further electrodes may be/are each connected to a third reference element 140c and a fourth reference element 140d. The third reference element and the fourth reference element may be/are each coupled to a mutually independent reference transmit electrode 111 of the plurality of reference transmit electrodes 111.

For example, each of the plurality of grid sensor units may be coupled to a respective transmit circuit 210, for example by means of the respective electrodes 110 and the respective reference transmit electrodes 111. The transmit circuit 210 may be configured to transmit one or more signals via the respective electrodes 110 and/or the respective reference transmit electrodes 111. For example, the grid sensor may be coupled to or comprise a voltage source 220, such as an AC voltage source.

For example, the plurality of grid sensor units may each be coupled to a receiving circuit, for example by means of the further electrodes 150 and the reference receiving electrodes 151. The receiving circuit may, for example, comprise one or more signal amplifiers 230 for amplifying a received (e.g. incoming) signal. For example, the receiving circuit may comprise one or more log-amp circuits 240 for converting a respective received signal into a logarithmically scaled signal. The receiving circuit may be configured to receive one or more signals by means of the plurality of further electrodes 150 and/or the plurality of reference receiving electrodes 151. The receiving circuit may be configured to forward received signals to a determining device 250.

The determination device 250 may, for example, be configured to store received measurement signals. For example, the grid sensor may comprise a calculation device configured to correct the measurement signals using reference signals.

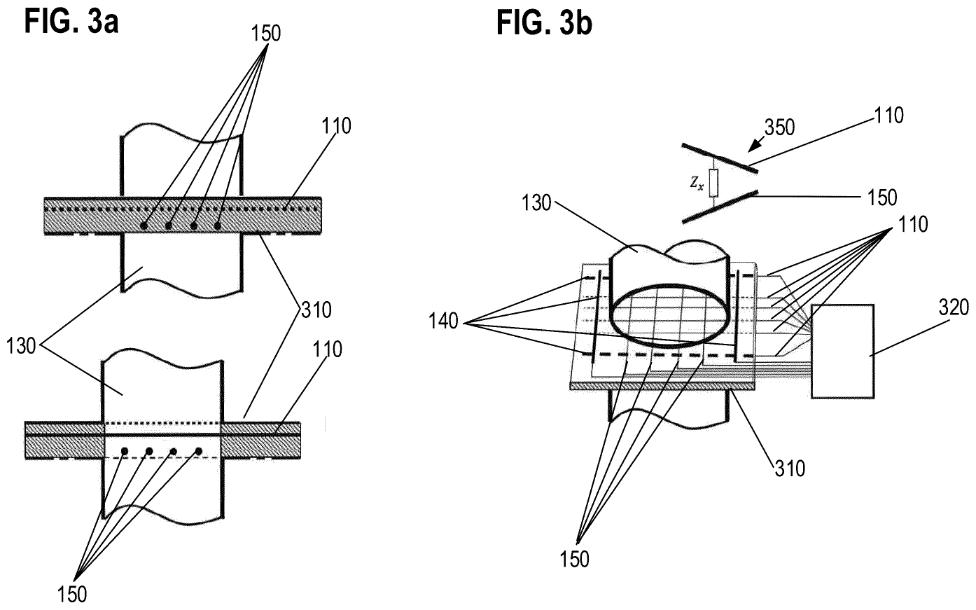

FIG. 3A shows two schematic sectional views of a grid sensor. For example, it may be recognized in FIG. 3A that the electrode 110 and the further electrodes 150 may be arranged in different planes. The upper view of FIG. 3A shows a first sectional view along a printed circuit board 310 in which, for example, one or more electronic circuits may be formed. The lower view, shows a second sectional view through the fluid guide region 130.

FIG. 3B shows a three-dimensional schematic measurement setup of a grid sensor and an equivalent circuit diagram 350. The grid sensor is shown schematically with a section through a fluid guide region 130 (e.g. in the form of a tube). The equivalent circuit diagram 350 illustrates a circuit realized, for example, by a single sensor element. A connection may be established between an electrode 110 and another electrode 150 within the sensor element, for example via the fluid, which may comprise an impedance Zₓ. However, the impedance Zₓ may also be realized by a real component between the electrode 110 and the further electrode 150.

The grid sensor may further comprise a control device 320 configured to transmit a signal sequence via the electrodes 110 and receive it by means of the further electrodes 150.

Errors in the measurement signals or measured values, which may be detected in the form of energy losses, may be corrected using the following method, for example.

Energy losses of grid sensor electrodes may be estimated using reference values (e.g. reference impedances, reference capacitances), which may be determined using reference elements located outside the detection range of the grid sensor. Each electrode may be connected to or may be a reference element. A reference element may, for example, be formed as a copper conductor track in a printed circuit board layout. For example, a reference element may be a discrete component such as a resistor, a capacitor, an inductor, a temperature sensor, and/or a semiconductor, or combinations of the foregoing.

A first measurement (e.g. a first calibration measurement) may be carried out with a sensor completely filled with air. The output signal of the reference element may be stored. In the case of a low energy loss (e.g., less than 5%, 2%, 1%, 0.5%, 0.1%, or less than 0.01%) of one or more electrodes (e.g., the transmitting electrodes and/or the receiving electrodes), a received reference signal may be equal to the output signal of the reference element. In such a case (low energy loss), the reference signal would represent that the one or more electrodes are subject to (almost) no interference (e.g., when the fluid guide region is completely filled with air or a similar (i.e., with a relative electrical dielectric constant between 0.1 and 5) gas or gas mixture, or is under vacuum). All calibration signals, including the reference signal that does not represent interference, may be stored. Using a suitable algorithm, the energy losses of the one or more electrodes may be estimated and corrected, taking into account the calibration signals (e.g. the reference signal or e.g. the reference signals). This is done, for example, by relating the reference signals, e.g. of an interference-free sensor, to new reference signals that may represent a sensor with an interference. The new reference signals may be determined during a specific measurement. Thus, for example, a method may be provided that may be used for a time-resolved and/or image-resolved (i.e. frame-by-frame) measurement (e.g. determination of interference).

For example, a measured value may be subjected to a measured value correction with linear demodulation, as described below.

The matrix of measured output voltages Uₒ^{x} is a measure that may represent the output voltage of each crossing point of the fluid flow cross-section of the fluid x. It may be represented as

$${U}_{o}^{measured , x} ( i , j , k ) = \frac{{U}_{o}^{ideal , x} ( i , j , k )}{ξ ( i , k )}$$

whereby Uₒ^{ideal,x} is an ideal measurement within the fluid x, i.e. without a loss, and ζ represents one or more losses of each electrode i represents. The indices i and j represent the electrodes (e.g. receiving electrodes and transmitting electrodes), and k is a consecutive number of a measurement. For example k may be used to correctly assign the various measurements (e.g. as measurement identification). For example, the number k may be used to output a time-resolved and/or image-resolved (i.e. frame-by-frame) corrected measurement result. Assuming that the losses of the electrodes are negligible when the sensor is completely filled with air, the ideal output voltages may be Uₒ^{ideal,air} may be approximated by measuring the output voltage in a calibration medium (e.g. in air may be ζ≈1 be) Uₒ^{measured,air} may be estimated as follows:

Based on this property, the signals of the external references may be collected for each receiver i may be collected before a particular experiment. For example, if no interferences occur (e.g. if the sensor is filled with air). Then stored data may be Uₒ^{measured,x}(i,0,k) from reference elements at j=0 may be used to deduct the energy losses ξ(i,k) for each subsequent experiment as follows (e.g. in real time):

$$ζ ( i , k ) \approx \tilde{ζ} ( i , k ) = \frac{{U}^{measured , air} ( i , 0 , k )}{{U}^{measured , x} ( i , 0 , k )} ,$$

whereby \tilde{ζ} is an estimate of a real loss ζ and the index j=0 indicates one or more reference elements (e.g. crossing points of the electrodes outside the fluid guide region of the grid sensor). Since the reference elements may have a constant impedance, they are only affected by the losses caused by the electrically conductive parts of the fluid flow in the fluid guide region. The corrected measured output voltages U^{x}_{corrected} may thus be given by

$${U}_{corrected}^{measured , x} ( i , j , k ) = {U}^{measured , x} ( i , j , k ) \tilde{ζ} ( i , k ) .$$

The measured value correction with linear demodulation may be transferred to a measured value correction with log-amp demodulation.

For example, the matrix of logarithmic measured output voltages U^{x}_{log} for an ideal (i.e. interference-free) state may be calculated as follows, taking the above relationships into account:

$${U}_{{o}_{log}}^{ideal , x} ( i , j , k ) = {v}_{a} \cdot log ( \frac{{U}_{o}^{ideal , x} ( i , j , k )}{{v}_{b}} )$$

whereby vₐ and v_{b} are constants of the log-amp circuit.

Assuming that the output voltages may be changed by interference, the following results for these:

$${U}_{{o}_{log}}^{measured , x} ( i , j , k ) = {v}_{a} \cdot log ( \frac{{U}_{o}^{ideal , x} ( i , j , k )}{ξ ( i , k )} \cdot \frac{1}{{v}_{b}} ) = {v}_{a} \cdot log ( \frac{{U}_{o}^{ideal , x} ( i , j , k )}{{v}_{b}} ) - {v}_{a} \cdot log ( ξ ( i , k ) ) .$$

As with linear demodulation, it may be assumed that a loss due to an interference in an air-filled grid sensor is negligible, which means that

$${v}_{a} \cdot log ( \frac{{U}_{o}^{measured , air} ( i , j , k )}{{v}_{b}} ) - 0 \approx {v}_{a} \cdot log ( \frac{{U}_{o}^{ideal , air} ( i , j , k )}{{v}_{b}} ) .$$

The loss due to the fault may be calculated using an external reference:

$${v}_{a} \cdot log ( \tilde{ξ} ( i , k ) ) = log ( {U}_{o}^{measured , air} ( i , 0 , k ) ) - log ( {U}_{o}^{measured , x} ( i , 0 , k ) ) ,$$

where j=0 represents the position of the reference.

This means that the entire measured value correction of the output voltages U_{o_log}_{_{corrected}}^{measured,x}(i,j,k) within the fluid x at the positions i, j and the measurement k may be given by

$${U}_{{o \_ log}_{corrected}}^{measured , x} ( i , j , k ) \approx {U}_{{o}_{log}}^{measured , x} ( i , j , k ) + {v}_{a} \cdot log ( \tilde{ξ} ( i , k ) ) .$$

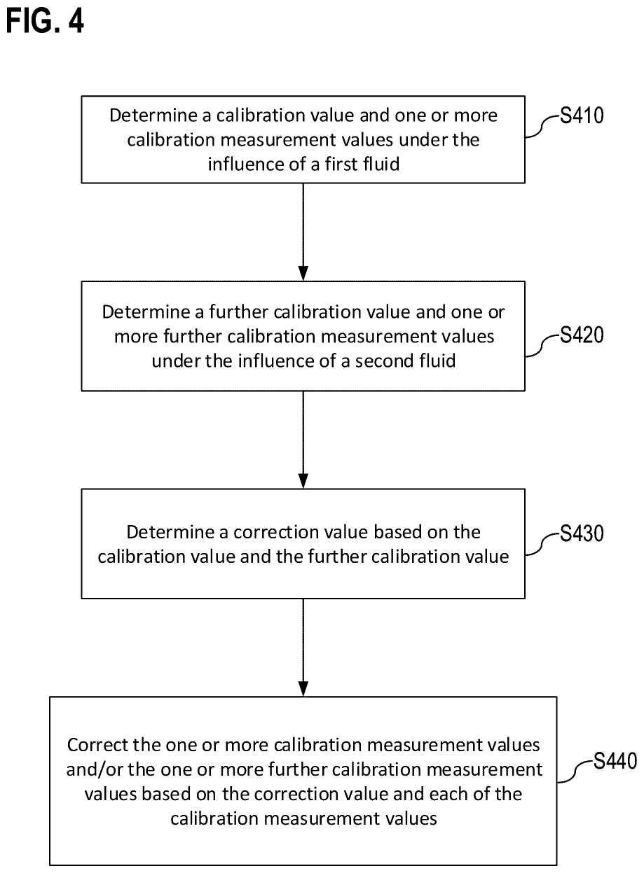

FIGS. 4 to 6 describe various exemplary embodiments of the methods for correcting measured values.

FIG. 4 schematically shows a method for calibrating a grid sensor.

In a first step, a calibration value and one or more calibration measurement values may be determined under the influence of a first fluid (S410). For example, the calibration value and the calibration measurement values may represent a state of the grid sensor in which a first fluid completely fills the fluid guide region of the grid sensor. The first fluid may be a gas or a liquid, for example.

Then, a further calibration value and one or more further calibration measurement values may be determined under the influence of a second fluid (S420). For example, the further calibration value and the one or more further calibration measurement values may represent a state of the grid sensor in which a second fluid completely fills the fluid guide region of the grid sensor. The second fluid may, for example, have a higher relative permeability than the first fluid. For example, the second fluid may be a liquid.

A correction value may then be calculated using the calibration value and the additional calibration value (S430).

In a final correction step, the one or more calibration measurement values and/or the one or more further calibration measurement values may be corrected (S440). One or more corrected calibration measured values may be determined (e.g. calculated) on the basis of the one or more calibration measured values and the correction value. One or more further corrected calibration measured values may be determined (e.g. calculated) on the basis of the one or more further calibration measured values and the correction value.

The one or more corrected calibration measured values or the one or more further corrected calibration measured values may be further evaluated using conventional methods in order to determine the electrical properties of the fluid under investigation.

For example, the method described may be used to estimate the magnitude of an interference. For example, the method described may be used to scale measured values.

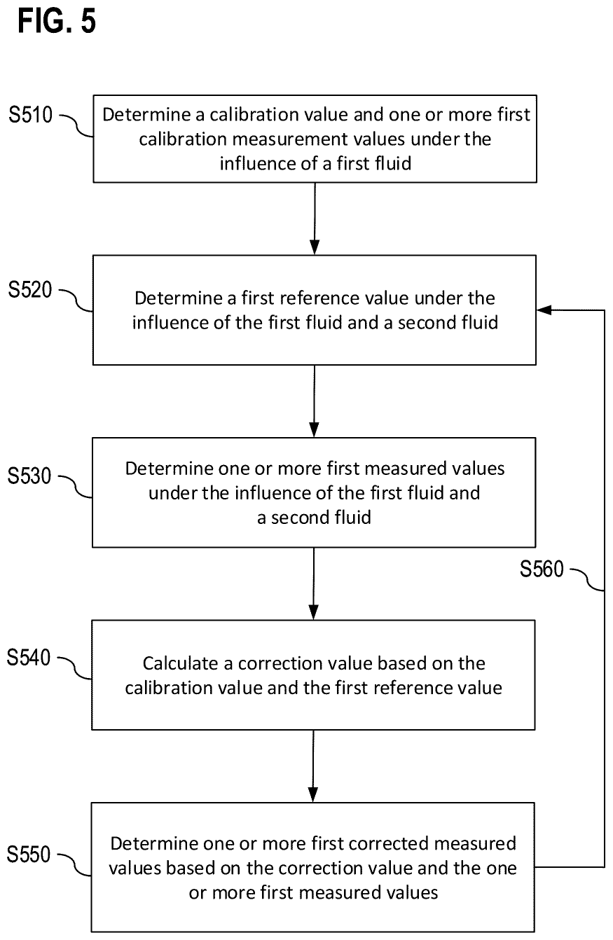

FIG. 5 schematically shows a method for correcting one or more measured values, e.g. from a reference element and a measurement of several sensor elements that are connected to this reference element.

A calibration value and one or more first calibration measurement values may be determined under the influence of a first fluid (S510). For example, the calibration value and the calibration measurement values may represent a state of the grid sensor in which a first fluid completely fills the fluid guide region of the grid sensor.

In connection, a first reference value may be determined under the influence of the first fluid and a second fluid (S520). For example, the first reference value may represent a state of the grid sensor in which at least a second fluid is present in the fluid guide region of the grid sensor in addition to the first fluid. This step may, for example, represent the start of a measurement.

Then, one or more first measured values may be determined under the influence of the first fluid and a second fluid (S530). For example, the one or more first measured values may represent a state of the grid sensor in which at least a second fluid is present in the fluid guide region of the grid sensor in addition to the first fluid. This step may, for example, represent a measurement of the fluid in the fluid guide region.

Based on the determined values, a correction value may be calculated on the basis of the calibration value and the first reference value (S540).

In the last step, one or more first corrected measured values may be calculated using the correction value and the one or more first measured values (S550).

The corrected measured values may be further evaluated using conventional methods, for example, to determine the properties of the fluid. If the measurement has not yet been completed, the method may be repeated from the determination of the first reference value (S560).

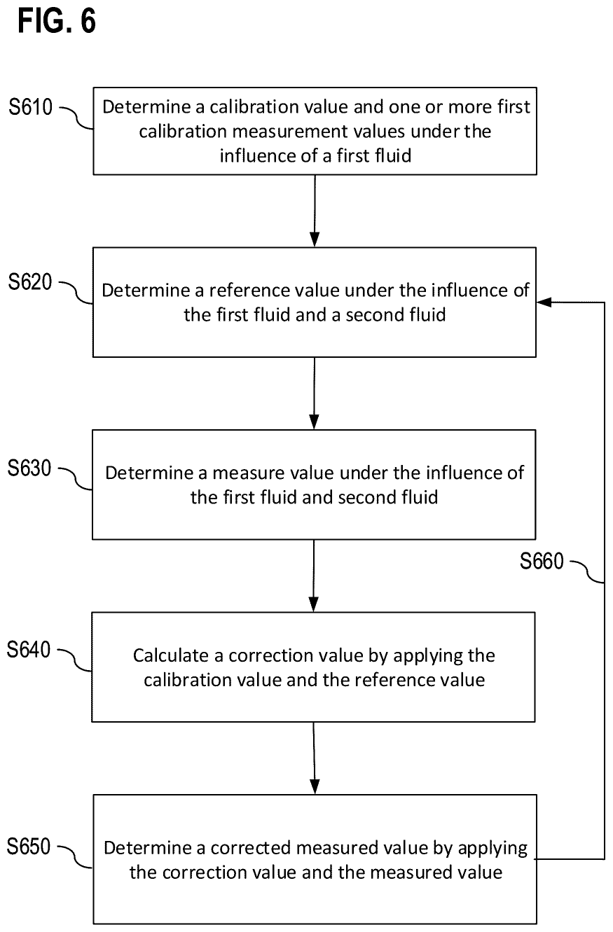

FIG. 6 schematically shows another method for correcting a measured value, similar to that in FIG. 5. In contrast to the method in FIG. 5, in this method a new reference value is determined between each determination of a measured value. This allows greater accuracy to be achieved if, for example, very fast measurement electronics are available. For example, the measured value and the reference value may be determined at the same time or within less than 50 ms (e.g. less than 10 ms, 1 ms or less than 0.1 ms). For example, only the transmitting electrodes may be switched sequentially. This means that new reference and measured values may always be obtained, which may be evaluated in a joint analysis.

For example, an energy loss may occur at the transmitting electrode if the material of an electrode is a poor conductor (e.g. stainless steel) and one of the phases present in the flow area is highly conductive. In this case, there is a high current flow on the transmitting electrode, which initially causes a non-negligible voltage drop across the electrode.

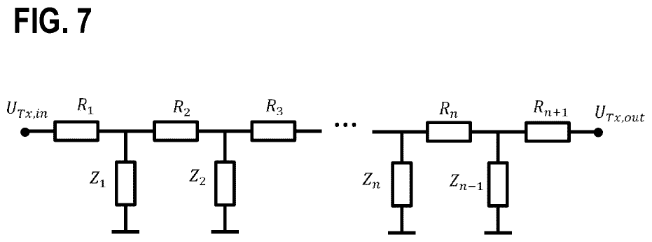

The energy loss at the transmitting electrode may be estimated by representing the measuring system as an equivalent circuit diagram, as shown in FIG. 7.

In FIG. 7 represents Rₓ (x=1, 2, 3, . . . , n+1) represents the resistor of an electrode segment that is calculated by

$${R}_{x} = \frac{{L}_{x}}{σ {A}_{cr}}$$

where Lₓ is the length of a segment of the transmitting electrode, o is the electrical conductivity of the electrode and A_{cr} is the cross-sectional area of the electrode. Zₓ is the impedance of the fluid associated with the crossing point x, which in turn may be theoretically estimated as

$${Z}_{x} = \frac{1}{\frac{1}{{σ}_{x}} + j {ωε}_{o} {ε}_{x}} ,$$

whereby σₓ and εₓ are the electrical conductivity or the relative permittivity of the fluid, w the angular frequency and j=\sqrt{−1}.

U_{Tx,in} and U_{Tx,out} are the reference voltages. They may be received using two approaches.

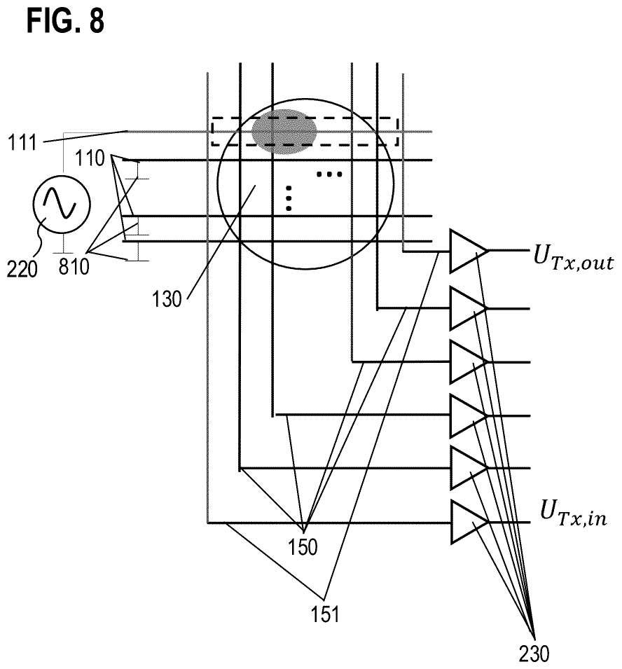

In the first approach U_{Tx,in} and U_{Tx,out} are received from external references 810 in analogy to the method for correcting the energy losses of the receiver wires (FIG. 8).

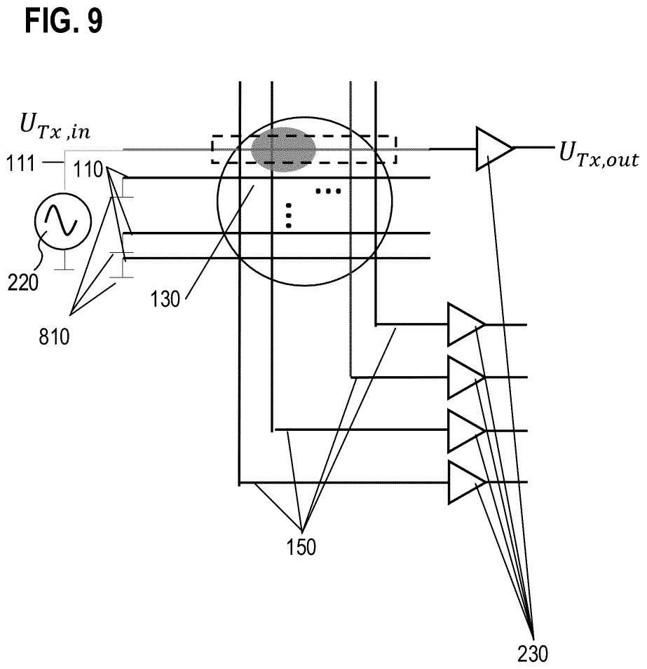

In the second approach U_{Tx,in} is equal to the voltage source (which is known a priori), and U_{Tx,out} is measured individually by an operational amplifier (FIG. 9).

The energy losses along the electrode are formulated based on Ohm's law and Kirchhoff's law:

$$\frac{{U}_{Tx , 1}}{{Z}_{1}} + \frac{{U}_{Tx , 1} - {U}_{Tx , in}}{{R}_{1}} + \frac{{U}_{Tx , 1} - {U}_{Tx , 2}}{{R}_{2}} = 0$$

$$\frac{{U}_{Tx , 2}}{{Z}_{2}} + \frac{{U}_{T x , 2} - {U}_{T x , 1}}{{R}_{2}} + \frac{{U}_{T x , 2} - {U}_{T x , 3}}{{R}_{3}} = 0$$

$$⋮$$

$$\frac{{U}_{Tx , n}}{{Z}_{n}} + \frac{{U}_{Tx , n} - {U}_{Tx , n - 1}}{{R}_{n}} + \frac{{U}_{Tx , 2} - {U}_{Tx , out}}{{R}_{n + 1}} = 0.$$

For the sake of simplicity, it may be represented in matrix form as follows

$$[ \begin{matrix}{p}_{1} & - {q}_{2} & 0 & 0 & … & 0 & 0 & 0 \\ - {q}_{1} & {p}_{2} & - {q}_{3} & 0 & & 0 & 0 & 0 \\ & ⋮ & & & ⋱ & & ⋮ & \\ 0 & 0 & 0 & 0 & & - {q}_{n - 2} & {p}_{n - 1} & - {q}_{n} \\ 0 & 0 & 0 & 0 & … & 0 & - {q}_{n - 1} & {p}_{n}\end{matrix} ] [ \begin{matrix}{U}_{Tx , 1} \\ {U}_{Tx , 2} \\ ⋮ \\ {U}_{Tx , n - 1} \\ {U}_{Tx , n}\end{matrix} ] = [ \begin{matrix}{q}_{1} \cdot {U}_{Tx , in} \\ 0 \\ ⋮ \\ 0 \\ {q}_{n} \cdot {U}_{Tx , out}\end{matrix} ]$$

where,

$${p}_{x} = ( \frac{1}{{Z}_{x}} + \frac{1}{{R}_{x}} + \frac{1}{{R}_{x + 1}} ) ,$$

$${q}_{x} = \frac{1}{{R}_{x}} .$$

The matrix form of the energy losses along the electrode shows a linear system of the type Ax=b where the energy loss is obtained by solving the linear system as x=A⁻¹b. The matrix form of the energy losses along the electrode has a single solution and may be used directly to correct the excitation signal of the respective crossing point.

The advantage of the second approach over the first approach is that there is no summation of the currents at the reference electrode. Assuming that all non-excited transmission wires are completely connected to ground and therefore make no contribution to the measured signal at the reference electrode, the first approach would be sufficient. However, with high conductivities and long wires, there is also a non-negligible voltage input on non-excited transmission wires, which may be correctly determined with the second approach. However, the second approach is associated with increased circuit complexity.

According to various aspects, a grid sensor is provided which is suitable for determining phase distributions in multiphase fluid flows. In particular in fluid flows with electrically (highly) conductive phase fractions, e.g. for investigating multiphase flows in the petroleum industry.

With conventional capacitive grid sensors, measurement deviations may occur in the presence of electrically conductive phases, for example in the form of non-linearities. This may cause signal losses at the receiving electrodes as a result of energy dissipation. The signal losses may depend on the respective wetting of the individual electrodes and/or sensor elements with the conductive phase and thus vary during the measurement process.

The exemplary designs of grid sensors described above and the methods described above may make it possible to quantify and thus correct the signal losses. This may improve the accuracy and informative value of a measurement using the grid sensor. In particular, it may be possible to quantify the phase components even in the presence of electrically (highly) conductive phases.

The following describes some examples that relate to what is described herein and shown in the figures.
Example 1 is a grid sensor which may comprise: a fluid guide region; one or more grid sensor units, wherein each of the one or more grid sensor units may comprise: a group of sensor elements configured to generate measurement signals which may represent one or more properties of a fluid guided in the fluid guide region; an electrode, wherein the sensor elements of the group of sensor elements may be connected to the electrode for operating (e.g. supplying and/or reading out) the sensor elements of the group of sensor elements; a reference element which may be associated with the electrode and may be configured to generate a reference signal representing an inference from the fluid guided in the fluid guide region on an electrical characteristic of the electrode.

For example, the reference element, which is assigned to the electrode, may be connected to the electrode.

For example, one sensor element of the group of sensor elements, several sensor elements of the group of sensor elements or all sensor elements of the group of sensor elements may be connected to the electrode. For example, the electrode may be configured to read out the sensor elements of the group and/or to receive one or more measurement signals from the group of sensor elements. For example, the electrode may be configured to supply the sensor elements of the group, e.g. with energy, and/or a current, and/or a voltage. For example, the electrode may be configured to transmit one or more transmission signals via the group of sensor elements.

An interference may be, for example, an interaction of a signal conducted in the electrode with the fluid conducted in the fluid guide region. For example, an interference may be a current flow via the fluid guided in the fluid guide region.
Example 2 is a grid sensor, according to example 1, wherein the one or more properties of the fluid comprise one or more of the following: an electrical conductivity, and/or a temperature, and/or a pressure.
Example 3 is a grid sensor according to example 1 or 2, wherein the sensor elements comprise or may be one or more temperature sensors, and/or one or more voltage sensors, and/or one or more pressure sensors, and/or one or more current sensors, and/or one or more inductance sensors, and/or one or more capacitance sensors, and/or one or more magnetic field strength sensors, and/or one or more light intensity sensors.
Example 4 is a grid sensor according to any one of examples 1 to 3, wherein the reference signal may represent or include one or more of the following values: a reference temperature, and/or a reference voltage, and/or a reference pressure, and/or a reference current, and/or a reference inductance, and/or a reference capacitance, and/or a reference magnetic field strength, and/or a reference luminous intensity, and/or a reference resistance.
Example 5 is a grid sensor according to one of examples 1 to 4, wherein the reference element may be arranged and/or configured in such a way that a predefined output signal is output by the reference element, on the basis of which the reference signal is generated. The predefined output signal may be independent of a fluid guided in the fluid guide region.

For example, the predefined output signal may be independent of a fluid guided in the fluid guide region, and the reference signal may be the altered predefined output signal that has been altered (e.g., influenced) by the interference (e.g., a disturbing influence) of the fluid guided in the fluid guide region on an electrical characteristic of the electrode.
Example 6 is a grid sensor according to example 5, whereby the reference element may be arranged outside the fluid guide region in order to avoid an influence of the fluid guided in the fluid guide region on the predefined output signal output by the reference element.
Example 7 is a grid sensor according to example 5 or 6, wherein the reference element is shielded from a fluid guided in the fluid guide region by means of a shield. For example, the reference element may be arranged within the fluid guide region.
Example 8 is a grid sensor according to example 7, wherein the shielding may be configured to shield the reference element from one or more influences of (or interactions with) the fluid guided in the fluid guide region: a heating, and/or a cooling, and/or a chemical reaction, and/or an electrical coupling, and/or a pressure, and/or an electromagnetic radiation, and/or an ionizing radiation. For example, the electrical coupling with the fluid may be a resistive, inductive or capacitive coupling. For example, the shielding may be or comprise an electrical insulator and/or a thermal insulator.
Example 9 is a grid sensor according to one of examples 1 to 8, wherein the reference element may be arranged on a printed circuit board. For example, neither the printed circuit board nor the reference element may have direct contact with the fluid guided in the fluid guide region.
Example 10 is a grid sensor according to any one of examples 1 to 9 optionally further comprising: a second electrode which may be connected to one sensor element of the group of sensor elements for operating the one sensor element.
Example 11 is a grid sensor according to example 10, wherein the electrode is configured to transmit a signal (e.g. a transmit signal) via one of the sensor elements of the group of sensor elements at a time; wherein the second electrode is configured to receive a measurement signal based on the signal and one or more properties of the fluid guided in the fluid guide region from the respective sensor element. For example, the signal from the electrode may be sent (e.g. simultaneously) across all sensor elements, and the second electrode may be configured to receive a measurement signal from a predetermined sensor element of the group of sensor elements. For example, the described modes of operation of the electrode and the second electrode may also be interchanged.
Example 12 is a grid sensor according to any one of examples 1 to 11, wherein the grid sensor may be configured such that the reference signal may correspond to a predefined output signal of the reference element when there is no interference from the fluid on the electrical characteristic of the electrode (i.e. that illustratively the unchanged output signal may be present), and that the reference signal may correspond to a superposition of the predefined output signal of the reference element with one or more interference signals if one or more interferences on the electrical characteristic of the electrode are present.
Example 13 is a grid sensor according to any one of examples 1 to 12, wherein the grid sensor may optionally further comprise one or more further groups of sensor elements, which may be configured to determine one or more properties of the fluid guided in the fluid guide region; one or more further electrodes, wherein one of the one or more further electrodes may be associated with each of the one or more further groups of sensor elements (e.g. for operating the sensor elements of the respectively assigned group); and one or more further reference elements, wherein one of the one or more further reference elements may be assigned to one of the one or more further electrodes and may be configured to provide a respective (illustratively assigned to the respective group, electrode, reference element) reference signal which may represent an interference from the fluid guided in the fluid guide region on an electrical characteristic of the respectively assigned electrode.
Example 14 is a grid sensor according to any one of examples 1 to 13, wherein the one or more properties of the fluid guided in the fluid guide region comprise a temperature of the fluid. For example, the one group of sensor elements configured to generate measurement signals may be configured to generate temperature dependent signals. For example, a temperature-dependent signal may be represented by a respective electrical resistor of the sensor elements of the group of sensor elements. For example, the sensor elements may be designed in such a way that their respective electrical resistance changes when the temperature of the fluid changes. For example, a group of sensor elements may be adapted for a respective temperature range.
Example 15 is a grid sensor according to example 14, whereby the reference element may be configured in such a way that the reference signal it provides is not dependent on the temperature of the fluid. For example, the reference signal may be represented by an electrical resistor of the reference element. For example, the reference element may be designed in such a way that its electrical resistance changes less (e.g. does not change) than the respective electrical resistances of the group of sensor elements when the temperature of the fluid changes. For example, the change in the electrical resistance of the reference element may be less than 10% (e.g. preferably less than 5%, more preferably less than 0.1%) of the change in each electrical resistance of the group of sensor elements. For example, a higher accuracy in a subsequent correction may be achieved by a very small change in the resistance of the reference element.
Example 16 is a grid sensor system which may comprise: a grid sensor according to any one of examples 1 to 15, a determination device which may be configured to determine (e.g. receive, read out, etc.) the reference signal from the grid sensor and to determine the measurement signals, and wherein a measurement signal of the measurement signals may be associated with a respective sensor element of the group of sensor elements. For example, the determination device and/or the calculation device may comprise a non-volatile memory.
Example 16 is a grid sensor system, according to example 16,
   wherein the determination device may be configured to determine a calibration value in a calibration measurement based on the reference signal, wherein the calibration value may represent a state of the grid sensor in which a first fluid may completely fill the fluid guide region of the grid sensor.
Example 18 is a grid sensor system, according to example 17,
   wherein the determining device may be configured to determine, in a first measurement, a first reference value based on the reference signal and first measurement values based on the measurement signals, wherein the first reference value and the first measurement values may represent a state of the grid sensor in which at least a second fluid in addition to the first fluid is present in the fluid guide region of the grid sensor, and wherein the first fluid and the second fluid differ from each other in at least one of the one or more properties by more than 1%, e.g. by more than 5%, 10%, 50%, 100%, 200%, 500% or by more than 1000%.

For example, the fluid guide region may be more than 1% filled with the first fluid, e.g., more than 2%, 3%, 4%, 5%, 10%, 20%, 30%, 40%, 50%, 60%, 70%, 80%, 90%, 95%, or more than 99%. For example, the fluid guide region may be more than 1% filled with the second fluid, e.g. more than 2%, 3%, 4%, 5%, 10%, 20%, 30%, 40%, 50%, 60%, 70%, 80%, 90%, 95%, or more than 99%.
Example 19 is a grid sensor system according to example 17, wherein the determining device may be configured to determine, in a first measurement, a first reference value based on the reference signal and first measurement values based on the measurement signals, wherein the first reference value and the first measurement values may represent a state of the grid sensor in which a second fluid completely fills the fluid guide region of the grid sensor, wherein the first fluid and the second fluid differ from each other in at least one of the one or more properties by more than 1%, e.g. by more than 5%, 10%, 50%, 100%, 200%, 500% or by more than 1000%. For example, the measurement according to this example may also be understood as a second calibration measurement, e.g. in order to estimate a possible maximum interval of the interference variables.

It is understood that, for example, time-resolved measurements may be enabled in accordance with examples 18 and 19. For example, after the first measurement, a further first measurement may be carried out (a so-called second measurement), the measured values of which and their reference value represent a further state. For example, the further state may be the same or different compared to the state according to examples 18 or 19. For example, a first and a second measurement may be carried out at a predetermined time interval from each other. Thus, for example, a time dependence of the states of the grid sensor may be determined. It is understood that the measurements may be repeated as often as desired to represent any number of states of the grid sensor. The multiple groups may be evaluated in real time using the following example, for example. For example, the multiple groups may also be stored for evaluation.
Example 20 is a grid sensor system according to example 18 or 19, wherein the second fluid may have a greater relative permittivity than the first fluid. For example, the relative permittivity of the second fluid may be greater than the relative permittivity of the first fluid by more than 10% (e.g., greater than 50%, 100%, 200%, 500%, or greater than 1000%).
Example 21 is a grid sensor system according to any one of examples 18 to 20, wherein the second fluid may be a liquid (e.g., water, oil, etc.) and the first fluid may be a gas (e.g., air, oxygen, nitrogen, etc.). For example, alternatively, the first fluid may be a liquid and the second fluid may be another liquid. For example, alternatively, the first fluid may be a gas and the second fluid may be another gas. For example, the first fluid may be a first phase of a substance and the second fluid may be a second phase of the substance. For example, the first fluid may be liquid water and the second fluid may be gaseous water or water vapor.
Example 22 is a grid sensor system according to any one of examples 18 to 21 optionally further comprising a calculation device which may be configured for calculating a correction value for correcting the interference based on the calibration value and the first reference value, and for calculating corrected first measurement values based on the first measurement values and the correction value.

For example, the calculation device may be integrated into the determination device. For example, the calculation device may comprise a non-volatile memory. For example, measured values, reference values, correction values and/or other values mentioned in this description may be stored in the non-volatile memory.

For example, the correction value may be a quotient of the first reference calibration value and the reference value of the electrode. For example, each of the corrected first measured values may be a product of the respective first measured value and the correction value. The calculation of the respective corrected first measured value may, for example, take place in real time and/or on the basis of previously stored data.

It is understood that the above examples may be applied to any of the one or more grid sensor units. For example, one of the one or more grid sensor units may be configured according to a first example and another of the one or more grid sensor units may be configured according to a second example. For example, the first and second examples may be the same or different from each other. For example, several or all of the one or more grid sensor units may be identical in construction. For example, at least one of the one or more grid sensor units may be different from another of the one or more grid sensor units.
Example 23 is a grid sensor system according to any one of examples 16 to 22, optionally further comprising: a memory device for storing one or more measurement data measured by the group of sensor elements and the reference signal. It is understood that in the case of a group of sensor elements, and/or a plurality of grid sensor units, and/or a plurality of measurements, the respective reference signals (i.e. respectively assigned to the grid sensor unit, respectively assigned to the sensor element of the group of sensor elements, and/or respectively assigned to the measurement) and/or the respective measurement signals (or values derived therefrom) are stored in such a way that a respective assignment (e.g. to the sensor element, to the grid sensor unit, to the measurement) is possible. This allows the measured states to be reconstructed even after a measurement.
Example 24 is a grid sensor system according to example 23, wherein the memory device comprises an interface for an external memory. For example, the interface may be a contactless interface (e.g. WLAN, transmitting device for an RFID chip, Bluetooth, infrared, NFC interface, etc.) or an interface with a contact (e.g. a wired interface (e.g. a USB interface, an RJ interface), a printer, a disc writer (e.g. for CD, DVD, BD, HD), etc.).
Example 25 is a grid sensor system according to example 23 or 24, wherein the memory device comprises one or more non-volatile memories (e.g. HDD, SSD, USB sticks, flash drives, memory sticks, floppy disk). For example, the one or more non-volatile memories may be reversibly or irreversibly writable.
Example 26 is a evaluation device (e.g. a measuring device), which may comprise: an input interface, which may be configured to receive measurement data and reference data of a sensor matrix (e.g. a grid sensor (e.g. of a grid sensor according to various aspects)) which may be at least partially surrounded by one or more fluids, wherein the measurement data may represent at least one property of the one or more fluids and may comprise an interference from the one or more fluids on the sensor matrix, and wherein the reference data may represent the interference from the one or more fluids on the sensor matrix; one or more processors, which may be configured to perform a measurement correction for generating corrected measurement data based on the measurement data and the reference data, wherein the measurement correction may correct the interference from the one or more fluids on the sensor matrix; and an output interface for outputting the corrected measurement data, which may represent at least one property of the one or more fluids and is independent of the interference from the one or more fluids on the sensor matrix. The calibration value may represent a calibration interference from exactly one of the one or more fluids on the sensor matrix.
Example 27 is an evaluation device according to example 26, wherein the sensor matrix may be one or more grid sensor units. For example, the sensor matrix may be a grid sensor according to examples 1 to 15. For example, the evaluation device may be coupled to a grid sensor system according to any one of examples 15 to 25.
Example 28 is an evaluation device according to example 26 or 27, wherein at least one property of the fluid may be one property from the following: a temperature, a pressure, a viscosity, an electrical conductivity, an impedance, a relative permeability, an electrical charge, a magnetic property, a close order of the atoms or molecules of the fluid, a state of aggregation, a nuclear charge number, a chemical composition, and/or a velocity of the fluid. For example, the measurement data and the corrected measurement data may represent multiple properties of each of the one or more fluids. In this case, the multiple properties may comprise or be one or more of the aforementioned properties.
Example 29 is an evaluation device according to one of examples 26 to 28, wherein the one or more processors may be arranged in at least one computer. For example, the computer may be coupled to the evaluation device or integrated into the evaluation device. For example, the computer may be a device or an assembly of devices, each of which may comprise one or more processors, such as a laptop, a Mac, a PC, a tablet, or a smartphone. For example, the one or more processors may comprise one or more of the following integrated circuits: ASIC, ASSP, DSP, FPGA, microcontroller, and/or SOC.
Example 30 is an evaluation device according to any one of examples 26 to 29, wherein the reference data may comprise one or more reference values and at least one calibration value, wherein the measurement data may comprise one or more measurement values, wherein each of the one or more measurement values and wherein the corrected measurement data may comprise one or more corrected measurement values. For example, each of the one or more corrected measured values may be associated with exactly one of the one or more measured values. For example, each of the one or more measured values may be associated with exactly one of the one or more corrected measured values. For example, the calibration value may represent a calibration interference from exactly one fluid of one or more fluids on a group of sensors.
Example 31 is an evaluation device according to example 30, wherein at least one of the one or more reference values may be assigned to each of the one or more measured values.
Example 32 is an evaluation device according to example 31, wherein the measured value correction may comprise: determining the respective correction value for each of the one or more measured values based on the calibration value and the at least one reference value associated with the respective measured value; and determining the one or more corrected measured values, wherein each of the one or more corrected measured values is calculated based on the correction value and the respective associated measured value of the one or more measured values. For example, the respective correction value may be a quotient calculated from the calibration value and the at least one reference value associated with the respective measured value. For example, the respective corrected measured value may be a product based on the respective measured value and the respective correction value. For example, the respective corrected measured value may be a sum based on the respective measured value and a logarithm of the respective correction value. It is understood that the measured value correction may be extended by calculations based on sensor matrix-specific parameters.
Example 33 is a computer program product that may comprise instructions that may cause one or more processors to perform the following: loading a data set that may comprise a calibration value, a first group of measurement values, and a first reference value, wherein the calibration value may represent a calibration interference from exactly one fluid of one or more fluids on a group of sensors, wherein the first reference value may represent a first interference on the group of sensors by the one or more fluids, wherein each measured value of the first group of measured values may represent a property of the one or more fluids and the first interference on the group of sensors, and wherein each measured value of the first group of measured values may be associated with one sensor of a group of sensors; determining a correction value from the calibration value and the first reference value; and correcting each measurement value of the first group of measurement values using the correction value.
Example 34 is a computer program product according to example 33,
   comprising determining a correction value from the calibration value and the first reference value: forming a quotient based on the calibration value and the first reference value. For example, the quotient may still be logarithmized. For example, further predetermined calibration parameters may be included in determining the calibration value. Calibration parameters may, for example, be parameters that are predetermined by the measuring system with which the data was recorded.
Example 35 is a computer program product according to example 33 or 34, wherein correcting each of the measured values of the first group of measured values by means of the correction value may comprise forming a product or sum based on the correction value and each of the readings of the first group of readings. For example, further predetermined correction parameters may be included in determining the calibration value. Correction parameters may, for example, be parameters that are predetermined by the measurement system with which the data was recorded.
Example 36 is a grid sensor, which may comprise a fluid guide region for guiding a fluid; a plurality of sensor elements for generating measurement signals representing one or more properties of the fluid guided in the fluid guide region, wherein the plurality of sensor elements may be arranged in a matrix arrangement; a plurality of first electrodes and a plurality of second electrodes, each sensor element of the plurality of sensor elements being connected to a respective one of the first electrodes and to a respective one of the second electrodes for operating the sensor element; a plurality of reference elements, each reference element being associated with a respective one of the first electrodes for providing a respective reference signal associated with the first electrode, which reference signal may represent an interference from the fluid guided in the fluid guide region on an electrical characteristic of the electrode.
Example 37 is a grid sensor which may comprise a sensor grid of transmitting electrodes and receiving electrodes. The transmitting electrodes and receiving electrodes may be arranged in such a way that the sensor grid may have crossing points, so-called measurement crossing points, arranged within the flow cross-section of a flow to be characterized (e.g. a fluid flow) (e.g. each with a sensor element) and crossing points, so-called reference crossing points, arranged outside the flow cross-section (each with a reference element). The reference intersections may be formed by the intersections of the receiving electrodes running through the flow cross-section with the reference electrodes running completely outside the flow cross-section with the transmitting electrodes. The measured values captured at the reference crossing points may be used to determine and compensate for the crossover points. The reference electrodes may, for example, be arranged in a base board of an actual grid sensor element; alternatively, impedances may also be provided instead of the reference electrodes.

It will be understood that the preceding examples relating to grid sensors may also be related to examples 36 and 37.
Example 38 is a grid sensor system which may comprise a fluid guide region for guiding a fluid; an electrode disposed in the fluid guide region, a reference signal source for generating a reference signal (e.g. a current, and/or a voltage) in the electrode; a reference signal receiver for receiving the reference signal (e.g. as a current or a voltage), a signal evaluation unit for evaluating the received reference signal, wherein the received reference signal indicates an interference from the fluid flowing in the fluid guide region on an electrical characteristic of the electrode. It is understood that a reference signal in the form of a voltage may be assigned to a current and vice versa, for example by means of a resistor.

It is understood that the preceding examples relating to grid sensor systems may also be related to example 38. Furthermore, embodiments of grid sensors according to one of the preceding examples may also be applied to the example 38.

It is further understood that a grid sensor described herein, a grid sensor system described herein, an evaluation device described herein and a computer program product described herein may be configured in an analogous manner for correcting an interference of a component comprising the respective grid sensor, the respective grid sensor system, the respective evaluation device or the respective computer program product. In such a case, the fluid guide region would be a component receiving region for receiving a component to be examined or the respective grid sensor may be attached (e.g. mounted) to the component. An associated grid sensor is described by way of example in examples 39 and 40 below. It is further understood that the aspects described herein, in particular the aspects described in examples 1 to 38, may be transferred to the grid sensor of example 39 and 40 in an analog manner. Thus, for example, a calibration of the grid sensor may be simplified, since only the reference elements need to be calibrated and a component-specific calibration is only necessary to a small extent (e.g. no longer necessary). In this case, for example, the lack of component-specific calibration may be understood as an interference of the component.
Example 39 is a grid sensor which may comprise: a component receiving area for receiving a component to be examined; one or more grid sensor units, wherein each of the one or more grid sensor units may comprise: a group of sensor elements configured to generate measurement signals which may represent one or more properties of a component received in the component receiving area; an electrode, wherein the sensor elements of the group of sensor elements may be connected to the electrode for operating (e.g. supplying and/or reading out) the sensor elements of the group of sensor elements; a reference element which may be associated with the electrode and may be configured to generate a reference signal which may represent an interference from a component received in the component receiving area on an electrical characteristic of the electrode.
Example 40 is a grid sensor for attachment (e.g. mounting) to a component, the grid sensor comprising: one or more grid sensor units, wherein each of the one or more grid sensor units may comprise: a group of sensor elements configured to generate measurement signals which may represent one or more properties of a component; an electrode, wherein the sensor elements of the group of sensor elements may be connected to the electrode for operating (e.g. powering and/or reading) the sensor elements of the group of sensor elements; a reference element which may be associated with the electrode and may be configured to generate a reference signal which may represent an interference from a component.

1. A grid sensor comprising:
a fluid guide region; and
a plurality of grid sensor units, each of the plurality of grid sensor units comprising:
a group of sensor elements configured to generate measurement signals representing one or more properties of a fluid guided in the fluid guide region;
an electrode, wherein the sensor elements of the group of sensor elements are connected to the electrode for operating the sensor elements of the group of sensor elements; and
a reference element that is associated with the electrode, is connected to the electrode, and is configured to provide a reference signal which represents an interference from the fluid guided in the fluid guide region on an electrical characteristic of the electrode.

2. The grid sensor according to claim 1,
wherein the one or more properties of the fluid may comprise one or more of the following: an electrical conductivity; a temperature; and a pressure.

3. The grid sensor according to claim 1,
wherein the sensor elements of the group of sensor elements comprise one or more temperature sensors, one or more voltage sensors, one or more pressure sensors, one or more current sensors, one or more inductance sensors, one or more capacitance sensors, one or more magnetic field strength sensors, one or more light intensity sensors.

4. The grid sensor according to claim 1,
wherein the reference signal represents one or more of the following: a reference temperature; a reference voltage; a reference pressure; a reference current strength; a reference inductance; a reference capacitance; a reference magnetic field strength; a reference luminous intensity; and a reference resistance.

5. The grid sensor according to claim 1,
wherein the reference element is configured to output a predefined output signal,
wherein the predefined output signal is independent of a fluid guided in the fluid guide region,
and wherein the reference signal is the predefined output signal modified by the interference from the fluid guided in the fluid guide region on an electrical characteristic of the electrode.

6. The Grid sensor according to claim 5,
wherein the reference element is arranged outside the fluid guide region for avoiding an influence of the fluid guided in the fluid guide region on the predefined output signal output by the reference element.

7. The grid sensor according to claim 1,
wherein the reference element is shielded from a fluid guided in the fluid guide region by means of a shield.

8. The Grid sensor according to claim 1,
wherein the grid sensor is configured such that the reference signal corresponds to a predefined output signal of the reference element when there is no interference from the fluid on the electrical characteristic of the electrode, and
such that the reference signal corresponds to a superposition of the predefined output signal of the reference element with one or more interference signals if one or more interferences on the electrical characteristics of the electrode are present.

9. A grid sensor system comprising:
a grid sensor according to claim 1; and
a determining device configured to determine the reference signal and to determine the measurement signals,
wherein one measurement signal of each of the measurement signals is assigned to a sensor element of the group of sensor elements.

10. The grid sensor system according to claim 9,
wherein the determining device is configured to determine a calibration value in a calibration measurement based on the reference signal, wherein the calibration value represents a state of the grid sensor in which a first fluid completely fills the fluid guide region of the grid sensor.

11. The grid sensor system according to claim 10,
wherein the determining device is configured to determine, in a first measurement, a first reference value based on the reference signal and first measurement values based on the measurement signals, wherein the first reference value and the first measurement values represent a state of the grid sensor in which at least a second fluid in addition to the first fluid is present in the fluid guide region of the grid sensor, and
wherein the first fluid and the second fluid differ from each other by more than 1% in at least one of the one or more properties.

12. The Grid sensor system according to claim 10,
wherein the determining device is configured to determine, in a first measurement, a first reference value based on the reference signal and first measurement values based on the measurement signals, wherein the first reference value and the first measurement values represent a state of the grid sensor in which a second fluid completely fills the fluid guide region of the grid sensor,
wherein the first fluid and the second fluid differ from each other by more than 1% in at least one of the one or more properties.

13. The Grid sensor system according to claim 11,
the second fluid comprising a greater relative permittivity than the first fluid.

14. The grid sensor system according to claim 11,
where the second fluid is a liquid and the first fluid is a gas.

15. The Grid sensor system according to claim 11, further comprising
a calculation device which is configured to:
calculate a correction value for correcting the interference based on the calibration value and the first reference value; and
calculate corrected first measured values based on the first measured values and the correction value.

16. The grid sensor system according to claim 11, further comprising:
a calculation device configured to calculate a correction value for correcting the interference based on the calibration value and the first reference value, and to calculate corrected first measured values based on the first measured values and the correction value.

17. An evaluation device comprising:
an input interface configured to receive measurement data and reference data from a grid sensor according to claim 1, wherein the grid sensor may be at least partially surrounded by one or more fluids,
wherein the measurement data represents at least one property of the one or more fluids and comprises an interference from the one or more fluids on the grid sensor, and
wherein the reference data represents the interference from the one or more fluids on the grid sensor;
one or more processors,
configured to perform a measurement value correction to create corrected measurement data based on the measurement data and the reference data,
wherein the measured value correction corrects the interference from the one or more fluids on the grid sensor; and
an output interface for outputting the corrected measurement data, which represents at least one property of the one or more fluids and is independent of the interference from the one or more fluids on the grid sensor.

18. A non-transitory computer-readable medium comprising instructions that, when executed, cause one or more processors to execute the following:
load a data set determined by a grid sensor according to claim 1, wherein the data set comprises a calibration value, a first group of measured values and a first reference value,
wherein the calibration value represents a calibration interference from exactly one fluid of one or more fluids on a group of sensors,
wherein the first reference value represents a first interference on the group of sensors by the one or more fluids,
wherein each measured value of the first group of measured values represents a property of the one or more fluids and the first interference on the group of sensors, and
wherein each measured value of the first group of measured values is assigned to one sensor of a group of sensors; and
determine a correction value from the calibration value and the first reference value; and
correct each measured value of the first group of measured values using the correction value.
